(19) United States
(12) Patent Application Publication
(10) Pub. No.: US 2006/0096663 A1
(43) Pub. Date: May 11, 2006

(54) Profile device

(76) Inventor: Krister Edlund, Enskede (SE)

Correspondence Address: OSTROLENK FABER GERB & SOFFEN, 1180 AVENUE OF THE AMERICAS, NEW YORK, NY, 100368403, US

(21) Appl. No.: 11/253,783

(22) Filed: Oct. 19, 2005

(30) Foreign Application Priority Data
Nov. 11, 2004 (SE) 0402745-4

(51) Int. Cl. B27C 9/00

(52) U.S. Cl. 144/4.2

(57) ABSTRACT

Profile device comprising a U-profile piece formed from a sheet-metal blank and comprising a bottom web and two substantially parallel branches connected thereto, the profile piece having a longitudinal direction and at least one cut through a first of the branches and through the web, so that the profile piece is bendable in the plane of the web around an axis normal to the web plane, and a sheet-metal element being provided along the U-profile piece in order to bridge over the cut and being connectable with profile piece portions, spaced-apart by the cut. The sheet-metal element is connectable with at least one of the profile piece portions by means of a glue joint that comprises a pre-assembled glue layer on a first of the two surfaces that are to be connected to each other and a tear-off foil on the side of the glue layer that is turned from the first of the surfaces, whereby the strip element and the first branch may be joined to each other substantially in a plane-parallel fashion via the glue joint after removal of the tear-off foil.

The invention relates to a profile device of the type defined in the preamble of claim 1.

Such a device comprises one or more U-profile pieces, which are initially bendable in the plane of the web of the U-pro-file. Such profile pieces may be end joined to each other for the formation of a U-profile channel of selectable/adjustable curvature in the web plane. The profile pieces are suitably manually bendable and are then stabilized to the curvature and position thereof on an appurtenant support surface, for instance on a floor and on a ceiling in a room, the branches of the profile pieces being directed towards the interior of the room. Usually, on that occasion the profile devices are established in a common vertical surface, having a selected adjusted curvature/extension in the horizontal plane. Between these profile devices, then vertical studs/wall studs are mounted, the ends of which being received in the respective U-profile, and which form a frame for a vertical wall curved in the horizontal plane. This frame may then be dressed with wall panels. Of course, the profile devices may also be mounted in a straight shape for the formation of a U-profile channel of a flat wall portion, but the profile device may naturally be mounted on a support in any orientation.

A problem is that the previously known profile devices are intricate to stabilize in the adjusted (curved) shape thereof.

Another problem in previously known profile devices that may be given a selected curvature in the web plane thereof, is that they have a complicated structure in order to have an expedient stability for handling and during bending to the desired curvature.

Hence, an object of the invention is to provide a profile device, the profile piece of which has good handling stability, readily can be given the desired curvature, has a simple structure, and/or readily can be stabilized in the adjusted curvature.

An additional object of the invention is to provide a particularly favourable technique for stabilising bent profile pieces for the formation of a profile device.

The objects are entirely or partly attained by the invention.

The invention is defined in the appended claim 1.

Embodiments of the invention are defined in the appended dependent claims.

According to an important feature of the invention, the parts of the web of the profile piece that are spaced-apart by the cut in the longitudinal direction have a mutual overlapping in two areas spaced-apart along the cut, the overlapping being arranged in opposite directions in the two areas. In this way, the profile piece gets a torsional rigidity around the longitudinal axis thereof and can be handled conveniently in connection with bending and mounting. An additional important feature is that means, for instance a flexible gummed tape, is applied to and along the profile piece in order to resist an unintentional bending of the profile piece, which entails that the overlappings are eliminated by bending the profile piece in the “wrong” direction. The gummed tape offers no notable resistance to a bending of the profile piece in the “correct” bending direction (for which the overlapping length is increased).

In one embodiment, the profile piece is fixed in the selected bending state thereof by the fact that a stabilising element is bridgingly fixed on the first profile branch of the profile piece across the cut by agglutination on at least one side of the cut. In that connection, the glue may be applied to the first branch or to the stabilising element beforehand, and furthermore, the pre-applied glue may be covered with a tear-off foil/release foil, which is removed before the jointing. The stabilising element may be a sheet-metal strip applied to and along the first profile branch. The sheet-metal strip is, to a certain extent, bendable and can readily be manually form fitted to the curved shape of said profile branch. In another, particular embodiment, the stabilising element may be in the form of a sheet-metal piece projecting from the verge of the first profile branch and being connected thereto via a bendable portion in order to be foldable downwards to the first branch and across the cut. In such an embodiment, a stabilising element is conveniently provided for each cut that is to be bridged over, for the stabilisation of the profile piece.

In the following, the invention will be described by way of example, reference being made to the appended drawing.

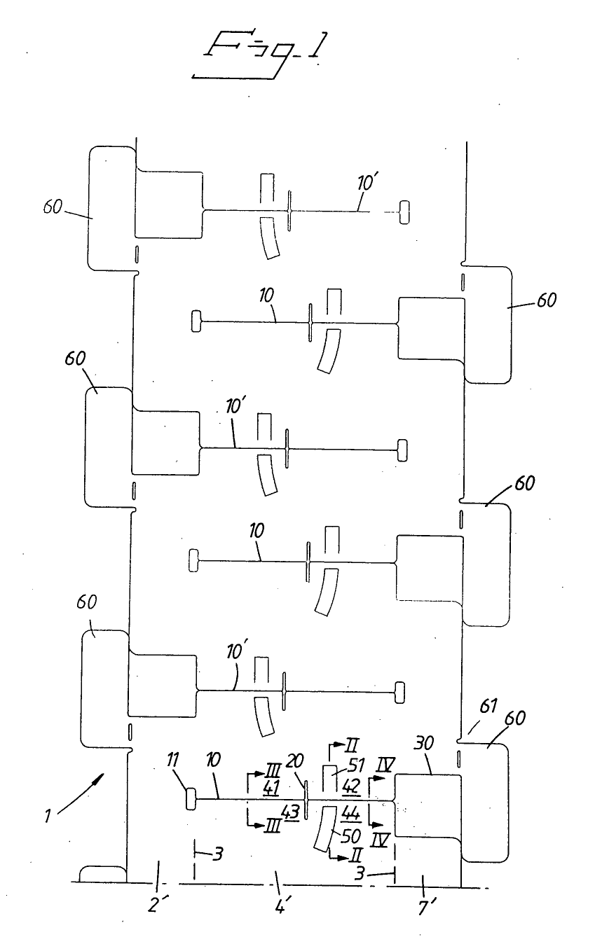

FIG. 1 shows schematically a longitudinal section of a flat sheet-metal blank, which may be raised for the formation of a U-shaped profile piece.

FIG. 2 shows a schematic section taken along the line II-II in FIG. 1.

FIG. 3 shows schematically a section taken along the line III-III in FIG. 1.

FIG. 4 shows schematically a section taken along the line IV-IV in FIG. 1.

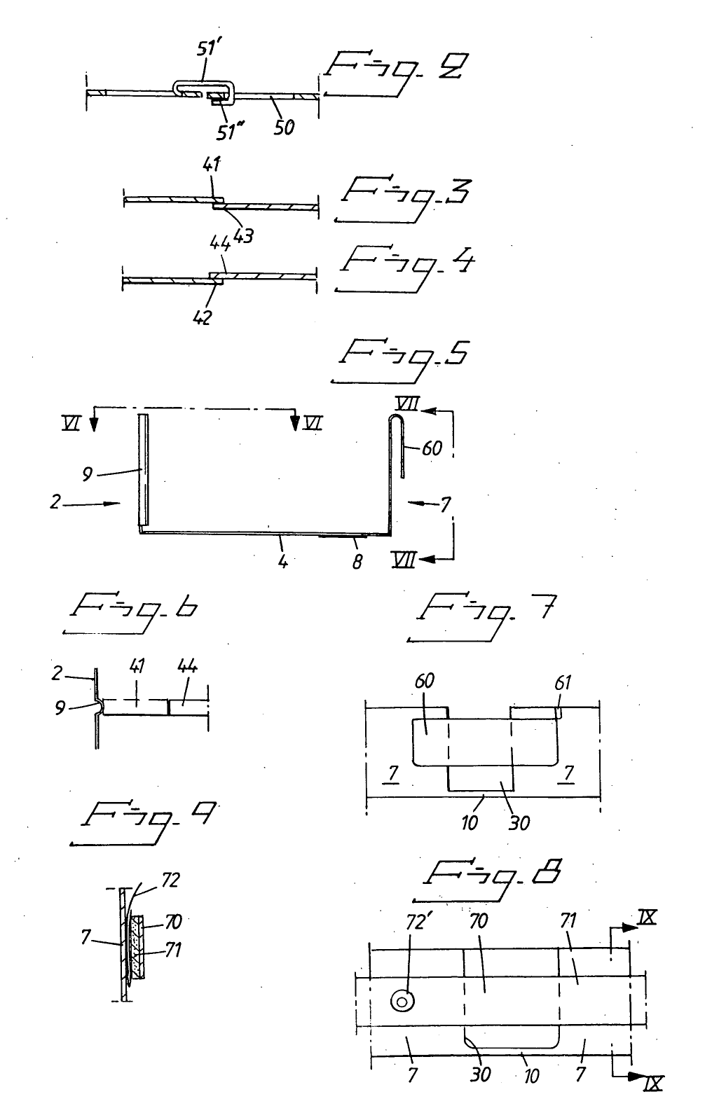

FIG. 5 shows schematically a cross-section through a U-profile piece formed from the blank according to FIG. 1.

FIG. 6 shows schematically a view taken along the line VI-VI in FIG. 5.

FIG. 7 shows schematically a view taken along the line VII-VII in FIG. 5.

FIG. 8 shows a variant of the subject-matter of the invention, in a depiction corresponding to FIG. 7.

FIG. 9 shows schematically a section taken along the line IX-IX in FIG. 8.

FIG. 1 shows a section of an elongate sheet-metal strip 1, having two verge portions 2′, which may be bent up around bending lines 3 for the formation of a U-profile (FIG. 5), which thereby obtains two parallel branches 2, extending suitably perpendicularly to a flat web 4. In the longitudinal direction 6 thereof, the profile piece is provided with at least one cut 10, which extends transversely to, preferably perpendicularly to, the longitudinal direction 6, through the first branch 7 and through the web 4. In the neighbourhood of the width centre of the web 4, there is a longitudinal slot 20 crossing the cut 10. In the inner end of the cut 10, a widened cut portion (opening) 11 is shown. In the initial portion of the cut 10, connecting to the free edge of the branch 7, a widened part 30 is present. On each side of the cut 10, tongues 41, 42 and 43, 44, respectively, are formed, which extend between the slot 20 and the widened portions, 11 and 30, respectively, of the slot 20. In the U-profile piece, the tongues 41, 43 and 42, 44, respectively, are brought to overlap each other, the overlapping between the tongues 41, 43 and 42, 44 being opposed, such as seen in FIG. 3 and FIG. 4. In this way, the web of the profile piece is stabilized against turning around the longitudinal direction of the profile piece. In order to keep the overlapping between the tongues 41-44, a gummed tape or the like is suitably applied to the profile piece, for instance underneath the web 4, near the branch 7. The applied tape has a relatively high tensile strength, thereby preventing the tongues from leaving their overlapping state, yet allowing the tongues to be mutually displaced into larger overlapping, for instance by the adhesive of the tape 8 having a relatively low peel strength or by the tape lacking adhesive binding to the web 4 in the immediate surroundings of the cut 10.

As another alternative, the web 4 may have an elongate, curved opening 50 on one side of the cut 10, the opening 50 preferably having a curved extension,. with the centre of curvature at the opening 11. On the other side of the cut, a tongue 51 is punched in the web 4. The tongue 51 extends from the vicinity of the cut 10 and in the longitudinal direction 6. The tongue 51 is directed towards the adjacent end of the opening 50. The tongue 51 may be bent over in order to bridge over the cut 10 and clasp the adjacent end edge of the opening 10, when the profile piece is in a principally straight state. The folded-over and clasping end portion of the tongue 51 may thereby be displaced along the opening 50 upon a bending of the profile piece around a bending axis that is essentially perpendicular to the web 4 and is situated in the branch 2. The folded-over end portion of the tongue 51, which clasps the short end of the opening 50, prevents the tongues 41, 43; 42, 44 from leaving the overlapping state thereof. The recess 30 prevents the adjacent end portions of the branches 7 to interfere with each other upon the bending of the profile piece around the inner end part of the cut 10. Before or during the raising of the branch 2 of the profile, the verge portion 2′ of the blank may be provided with a bending as an extension of the cut 10 from the opening 11, so that the edge of the cut 10 is mutually displaced in parallel and can assume the overlapping state without the profile piece needing to deflect from the straight state. By the fact that the beading 11 has an extension in the longitudinal direction 6, the establishment of the U-shaped or V-shaped profiling 9 in the branch 2 is facilitated.

The profile piece may have a plurality of cuts 10 being spaced-apart and conformally located along the profile piece and having functionally appurtenant details such as accounted for above, in order to raise the possibility for a stronger and more even distribution of the bending of the profile element in one direction from the longitudinal axis. Between the nearby cut 10, the corresponding cut 10′ may be placed, with the only difference that the cuts 10′ and the appurtenant details described above extend from the second branch 2 and the web 4, so that the profile piece subsequently can be bent in the other direction in the plane thereof.

From FIG. 1, it is apparent that the verge portion 7′ has an integrated, protruding sheet-metal piece 60 that is bridging over the widened portion 30 of the slot 10 in the longitudinal direction 6 and that is connected to the verge portion 7′ on one side of the widening 30 by means of a weak connection 61. The tongue 61 may be folded down around 180° towards the out-side of the branch 7 in the profile piece, when the same has been given the desired curvature thereof (slanting around the cut 10), at least the free end of the sheet-metal piece 60 being attached to the adjacent part of the branch 7 in order to mutually connect the longitudinal sections of the branch 7 spaced-apart by the slot portion 30, as can be seen from FIG. 7. The sheet-metal piece 60 may be connected to the branch 7 by means of a glue joint. The glue joint may be established by the fact that an adhesive surface applied to the sheet-metal piece 60 beforehand being protected by a tear-off foil/release foil, which is removed immediately before the bending-over of the sheet-metal piece 60 into contact with the surface of the branch 7, so that the binding is established when the sheet-metal piece 60 contacts the branch 7. Alternatively, of course the adhesive joint may be pre-assembled on the branch 7. In another embodiment, it is possible to omit the sheet-metal pieces 60 and instead provide an elongate, separate sheet-metal strip 70, which is mounted on and along the branch 7 of the profile piece after the profile piece has been given the desired curvature. On that occasion, the strip 70 may be connected to the branch 7 by means of some joint, for instance a pop rivet joint 72, or by means of a glue joint of the above-mentioned kind.

In FIG. 8, it is illustrated that the sheet-metal strip 70 on and along one of the sides thereof may have a pre-assembled glue layer 71, which is covered by a double-folded release foil strip 72, which may be pulled off from the area between the glue layer 71 and the branch 7 even if the strip 70 is held pressed against the branch 7.

The U- or V-shaped beading 9 in the branch 2/7 in question is not strictly required, but offers the possibility of producing the profile piece in selected state with conformal overlapping between the web tongues.

The expansion 11 of the cut 10 is preferably located in the verge portion 2′ and 7′, respectively, and has preferably a length in the direction 6 corresponding to the length of the material portion involved in the beading 9.

The profile pieces may be manufactured in manageable quantities and end joined to each other for the manufacture of a profile device of the desired length.

1. Profile device comprising a U-profile piece formed from a sheet-metal blank and comprising a bottom web and two substantially parallel branches connected thereto, the profile piece having a longitudinal direction and at least one cut through a first of the branches and through the web, so that the profile piece is bendable in the plane of the web around an axis normal to the web plane, and a sheet-metal element being provided along the U-profile piece in order to bridge over the cut and being connectable with profile piece portions spaced-apart by the cut wherein that the sheet-metal element is connectable with at least one of the profile piece portions by means of a glue joint that comprises a pre-assembled glue layer on a first of the two surfaces that are to be connected to each other and a tear-off foil on the side of the glue layer that is turned from the first of the surfaces, whereby the strip element and the first branch may be joined to each other substantially in a plane-parallel fashion via the glue joint after removal of the tear-off foil.

2. Profile device according to claim 1, wherein that the cut is supplemented with slot formations crossing the cut in order to form two pairs of opposite tongues in the web, that the tongues in the respective pair overlap each other, that the pairs are spaced-apart along the cut, that the pairs have opposite tongue overlapping so that the tongue pairs jointly stabilise the profile piece in respect of turning around the longitudinal direction, and that means are provided in order to keep the tongues in overlapping state.

3. Profile device according to claim 1, wherein that the means to keep the tongues in overlapping state comprise a flexible strip, which is attached to the bottom side of the web and bridges over the cut.

4. Profile device according to claim 1, wherein that the means to keep the tongues in overlapping state comprises an opening recessed in a first of two web portions spaced-apart by the cut, and a flap, which is cut in the second of said two web portions and which extends bent over through the punched opening.

5. Profile device according to claim 4, wherein that the sheet-metal element is formed integratedly with a verge portion of the first branch near the cut and is connected thereto via a resilient joint allowing manual folding-over of the sheet-metal element for bridging over the cut.

6. Profile device according to claim 1, wherein that the first supplementary cut of the cut is located adjacent to the second branch and is widened for the formation of an opening, and that the second branch is beaded near the bending axis, so that the tongues spaced-apart by the cut can be brought to overlapping while the profile piece is straight in the longitudinal direction thereof.

7. Profile device according to claim 1, wherein that the profile piece has a first series of cuts spaced-apart along the longitudinal direction.

8. Profile device according to claim 7, wherein that the profile piece has a second series of cuts that are spaced-apart along the longitudinal direction and that differ from those in the first series in that they extend through the second branch and through the web, and that the cuts of the first and the second series alternate in the longitudinal direction of the profile piece.

9. Profile device comprising a U-profile piece formed from a sheet-metal blank and comprising a bottom web and two substantially parallel branches connected thereto, the profile piece having a longitudinal direction and at least one cut through a first of the branches and through the web, so that the profile piece is bendable in the plane of the web around an axis that is normal to the web plane and situated near the second branch, and means being provided in order to mutually fix adjacent profile piece portions in the longitudinal direction that are separated by the cut, wherein that the cut is supplemented with slot formations crossing the cut in order to form two pairs of opposite tongues in the web, that the tongues in the respective pair overlap each other, that the pairs are spaced-apart along the cut, that the pairs have opposite tongue overlapping so that the tongue pairs jointly stabilise the profile piece in respect of turning around the longitudinal direction, and that means are provided in order to keep the tongues in overlapping state.
